(19) United States
(12) Patent Application Publication
(10) Pub. No.: US 2024/0284980 A1
(43) Pub. Date: Aug. 29, 2024

(54) AEROSOL GENERATING DEVICE AND AEROSOL GENERATING SYSTEM INCLUDING THE SAME

(71) Applicant: KT&G CORPORATION, Daejeon (KR)

(72) Inventors: Dong Sung KIM, Seoul (KR); Young Bum KWON, Yongin-si (KR); Yong Hwan KIM, Anyang-si (KR); Hun Il LIM, Seoul (KR)

(73) Assignee: KT&G CORPORATION, Daejeon (KR)

(21) Appl. No.: 18/410,418

(22) Filed: Jan. 11, 2024

(30) Foreign Application Priority Data
Feb. 23, 2023 (KR) 10-2023-0024596
May 10, 2023 (KR) 10-2023-0060562

(51) Int. Cl. A24F 40/465; A24F 40/48; A24F 40/51; A24F 40/53; H05B 6/10; H05B 6/44

(52) U.S. Cl. CPC A24F 40/465; A24F 40/48; A24F 40/51; A24F 40/53; H05B 6/105; H05B 6/44

(57) ABSTRACT

An aerosol generating device includes a housing including an air inlet through which air is introduced, and a heater module arranged inside the housing and configured to heat an aerosol generating article, wherein the heater module includes a receiving portion having a receiving space for accommodating the aerosol generating article, one or more coils configured to generate a magnetic field, a passage structure arranged on one side of the receiving portion and including one airflow passage configured to receive external air through the air inlet and transfer the received external air to the receiving portion, and a pressure sensor configured to generate a signal about a pressure inside the airflow passage.

### CROSS-REFERENCE TO RELATED APPLICATIONS

This application is based on and claims priority under 35 U.S.C. § 119 to Korean Patent Application Nos. 10-2023-0024596, filed on Feb. 23, 2023, and 10-2023-0060562, filed on May 10, 2023, in the Korean Intellectual Property Office, the disclosures of which are incorporated by reference herein in their entirety.

### BACKGROUND

### 1. Field

The disclosure relates to an aerosol generating device and a system therefor, and more particularly, to an aerosol generating device capable of efficiently heating a miniaturized susceptor.

### 2. Description of the Related Art

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, studies have been actively conducted on a heating-type aerosol generating device.

Recently, an aerosol generating device in an induction heating method, which generates aerosols by heating a cigarette or an aerosol generating material through an alternating magnetic field, has been proposed. In particular, the aerosol generating device in the induction heating method may include a coil that generates an alternating magnetic field as power is supplied, and a susceptor that generates heat when the alternating magnetic field generated by the coil is applied, and aerosols may be generated from an aerosol generating material by heating an aerosol generating article through heat generated by the susceptor.

### SUMMARY

An induction heating type aerosol generating device may include a susceptor and a coil, and the susceptor may be heated by a magnetic field generated by the coil, thereby transferring heat energy to an aerosol generating article. Recently, attempts to miniaturize the size of an aerosol generating device have increased to improve portability of the aerosol generating device and convenience for users.

Provided are an aerosol generating device with improved space efficiency and miniaturized size and an aerosol generating system including the aerosol generating device.

Provided are an aerosol generating device with improved heating efficiency by increasing a heating area of a susceptor, and an aerosol generating system including the aerosol generating device.

Provided are an aerosol generating device with improved sensing performance of physical quantities such as air pressure, temperature, and humidity inside the device, and an aerosol generating system including the aerosol generating device.

The technical problems to be solved by the embodiments of the disclosure are not limited to the above-described problems, and problems that are not mentioned will be clearly understood by those of ordinary skill in the art from the disclosure and the accompanying drawings.

Additional aspects will be set forth in part in the description which follows and, in part, will be apparent from the description, or may be learned by practice of the presented embodiments of the disclosure.

According to an embodiment, an aerosol generating device may include a housing including an air inlet through which air is introduced, and a heater module arranged inside the housing and configured to heat an aerosol generating article, wherein the heater module includes a receiving portion having a receiving space for accommodating the aerosol generating article, one or more coils configured to generate a magnetic field, a passage structure arranged on one side of the receiving portion and including one airflow passage configured to receive external air through the air inlet and transfer the received external air to the receiving portion, and a pressure sensor configured to generate a signal about a pressure inside the airflow passage.

According to another embodiment, an aerosol generating system may include an aerosol generating device including a housing including an air inlet through which air is introduced, and a heater module arranged inside the housing and configured to heat an aerosol generating article, wherein the heater module includes a receiving portion having a receiving space for accommodating the aerosol generating article, one or more coils configured to generate a magnetic field, a passage structure arranged on one side of the receiving portion and including one airflow passage configured to receive external air through the air inlet and transfer the received external air to the receiving portion, and a pressure sensor configured to generate a signal about a pressure inside the airflow passage, and an aerosol generating article including one or more thin films that generate heat by a magnetic field, wherein the one or more coils may apply a magnetic field to the one or more thin films of the aerosol generating article accommodated in the receiving portion.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of an aerosol generating system according to an embodiment;

FIG. 2 is a cross-sectional view for explaining each configuration of the aerosol generating system shown in FIG. 1;

FIG. 3 is a cross-sectional view for explaining components arranged inside a heater module of an aerosol generating device;

FIG. 4 is a front view for explaining components arranged outside a heater module of an aerosol generating device;

FIG. 5 is a cross-sectional view for explaining arrangements of a receiving portion and a coil of a heater module of an aerosol generating device, and a direction of a magnetic field;

FIG. 6 is a perspective view for explaining a circuit board formed integrally with sensors;

FIG. 7 is a perspective view for explaining components arranged outside a heater module of an aerosol generating device from another angle;

FIG. 8 is a perspective view for explaining an insulation pipe surrounding a receiving portion of a heater module of an aerosol generating device;

FIG. 9 is a front view for explaining an insulation pipe surrounding a receiving portion of a heater module of an aerosol generating device from another angle;

FIG. 10 is a top view for explaining an insulation pipe surrounding a receiving portion of a heater module of an aerosol generating device from another angle; and

FIG. 11 is a block diagram of an aerosol generating device according to another embodiment.

### DETAILED DESCRIPTION

With respect to the terms used to describe the various embodiments, general terms which are currently and widely used are selected in consideration of functions of structural elements in the various embodiments of the disclosure. However, meanings of the terms can be changed according to intention, a judicial precedence, the appearance of new technology, and the like. In addition, in certain cases, terms which can be arbitrarily selected by the applicant in particular cases. In such a case, the meaning of the terms will be described in detail at the corresponding portion in the description of the disclosure. Therefore, the terms used in the various embodiments of the disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, hen an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped susceptor, a plate-shaped susceptor, a needle-shaped susceptor, or a rod-shaped susceptor, and may heat the inside or outside of a cigarette according to the shape of a susceptor.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and the generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHZ, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated by the vibrator, and the heat and/or ultrasonic vibrations generated by the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the disclosure will now be described more fully with reference to the accompanying drawings, in which exemplary embodiments of the disclosure are shown such that one of ordinary skill in the art may easily work the disclosure. The disclosure may be implemented in a form that can be implemented in the aerosol generating devices of the various embodiments described above or may be implemented in various different forms, and is not limited to the embodiments described herein.

Hereinafter, embodiments of the disclosure will be described in detail with reference to the drawings.

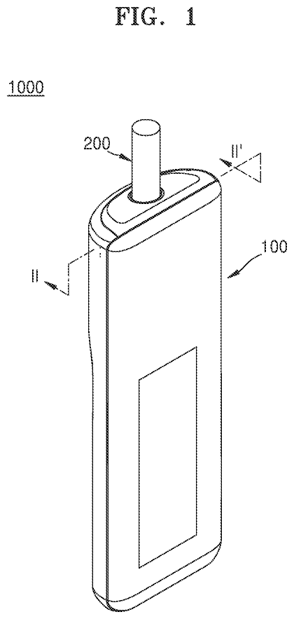

FIG. 1 is a perspective view of an aerosol generating system 1000 according to an embodiment. The aerosol generating system 1000 may include an aerosol generating device 100 and an aerosol generating article 200.

The aerosol generating device 100 may generate aerosols by heating the aerosol generating article 200. The aerosol generating article 200 may contain an aerosol generating material.

The aerosol generating article 200 may be separably coupled to the aerosol generating device 100, and may be replaced. The aerosol generating article 200 may be accommodated within a receiving portion separately provided in the aerosol generating device 100.

A cross section of the aerosol generating article 200 viewed in a longitudinal direction (+y or −y) may have a circular shape, but the cross-sectional shape of the aerosol generating article 200 is not limited thereto. For example, the cross section of the aerosol generating article 200 viewed in the longitudinal direction may have an oval shape or a polygonal shape such as a rectangular shape, or the like.

In an embodiment, the aerosol generating device 100 is a device that generates aerosols by heating the aerosol generating article 200 accommodated in the aerosol generating device 100 in an induction heating method. The induction heating method refers to a method of generating heat from a magnetic body by applying an alternating magnetic field.

When an alternating magnetic field is applied to a magnetic body, energy loss according to eddy current loss and hysteresis loss may occur in the magnetic body. The lost energy may be released from the magnetic body as thermal energy. The greater the amplitude or frequency of the alternating magnetic field, the more heat energy may be released from the magnetic body.

The aerosol generating system 1000 that generates aerosols in an induction heating method may include a susceptor and a coil. The susceptor may emit heat energy when a magnetic field is applied. The susceptor may be arranged inside the aerosol generating article 200. As power is supplied to the coil, the coil may form a magnetic field and apply the magnetic field to the susceptor.

The susceptor may be a thin film. The aerosol generating article 200 may include one or more thin films which are heated by a magnetic field and may function as insulators. For example, a thin film that generates heat by a magnetic field may be arranged inside the aerosol generating article 200. The thin film may be a magnetic body that generates heat when an external magnetic field is applied. As another example, the thin film may be a non-magnetic metal.

The thin film may include metal or carbon. The thin film may include at least one of ferrite, ferromagnetic alloy, stainless steel, and aluminum (AI). Also, the thin film may include at least one of graphite, molybdenum, silicon carbide, niobium, nickel alloy, metal film, ceramics such as zirconia or the like, a transition metal such as nickel (Ni), cobalt (Co), or the like, and a metalloid such as boron (B) or phosphorus (P). A thickness of the thin film may be at least about 1 μm but not more than about 100 μm.

The coil may apply a magnetic field to the thin film when the aerosol generating article 200 is accommodated into the receiving portion of the aerosol generating device 100. When a magnetic field is applied to the thin film inside the aerosol generating article 200, the thin film may generate heat and generate aerosols by heating an aerosol generating material inside the aerosol generating article 200.

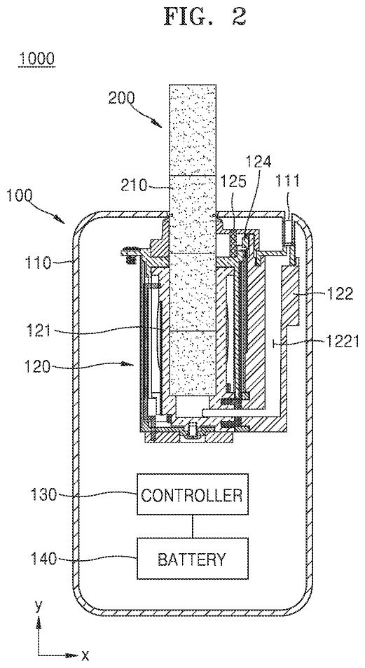

FIG. 2 is a cross-sectional view for explaining each configuration of the aerosol generating system 1000 shown in FIG. 1. Some components of the aerosol generating system 1000 may be the same as or similar to some components of the aerosol generating system 1000 shown in FIG. 1, and redundant descriptions are omitted below.

The aerosol generating device 100 may include a housing 110 forming an exterior and a space therein, a heater module 120 arranged inside the housing 110 and configured to heat the aerosol generating article 200, a battery 130 supplying power to components requiring power of the aerosol generating device 100, and a controller 140 controlling components of the aerosol generating device 100 and transmitting and receiving information to/from the components.

The housing 110 may include an air inlet 111 through which air outside the aerosol generating device 100 is introduced. The air inlet 111 may deliver air outside the aerosol generating device 100 to components of the heater module 120. The air inlet 111 may include a hole formed in an outer surface of the housing 110, and may include a flow path for transferring introduced air to other components.

The heater module 120 may include a receiving portion 121 arranged inside the housing 110 and configured to accommodate the aerosol generating article 200, a coil (not shown) generating a magnetic field, and a passage structure 122 transferring external air to the receiving portion 121.

The receiving portion 121 may include a receiving space for accommodating an aerosol generating article. An inner peripheral surface of the receiving portion 121, which faces the receiving space, may have a shape corresponding to a shape of the aerosol generating article 200. For example, when a cross section of the aerosol generating article 200 viewed in the longitudinal direction (+y or −y) has a circular shape or an oval shape, the inner peripheral surface of the receiving portion 121, which faces the receiving space, may have a curved surface in a shape corresponding to a shape of an outer peripheral surface of the aerosol generating article 200. As another example, when a cross section of the aerosol generating article 200 viewed in the longitudinal direction (+y or −y) has a polygonal shape such as a rectangular shape or the like, the inner peripheral surface of the receiving portion 121, which faces the receiving space, may include a flat surface corresponding to the outer peripheral surface of the aerosol generating article 200.

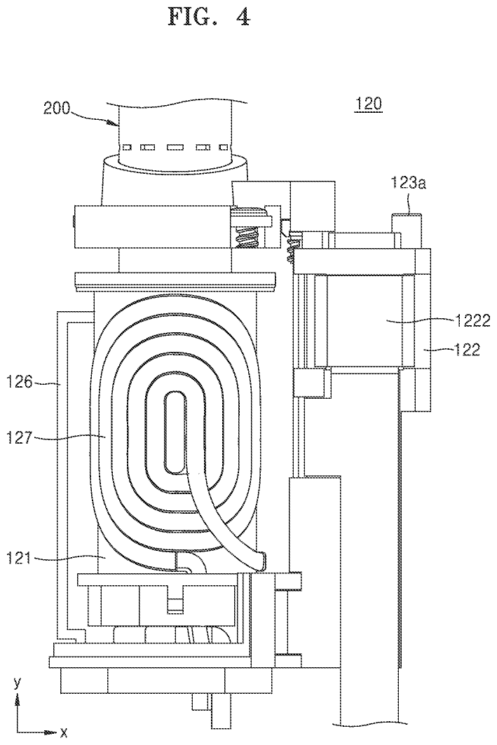

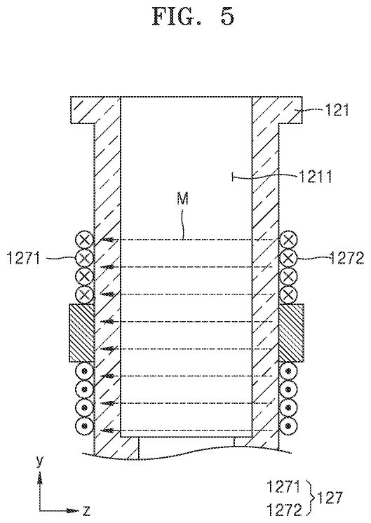

The coil (not shown) is a component that heats a thin film by generating a magnetic field. Detailed descriptions of a shape, a structure, and a function of the coil is made in detail with reference to FIGS. 4 and 5.

The passage structure 122 may be arranged on one side of the receiving portion 121. For example, the passage structure 122 may be arranged in a lateral direction (+x or −x) from the receiving portion 121, but a position of the passage structure 122 is not limited thereto. As another example, the passage structure 122 may be arranged in an upward direction (+y) or a downward direction (−y) from the receiving portion 121.

The passage structure 122 is a component that receives air outside the aerosol generating device 100 through the air inlet 111 to transfer to the receiving portion 121. One airflow passage 1221 may be formed in the passage structure 122.

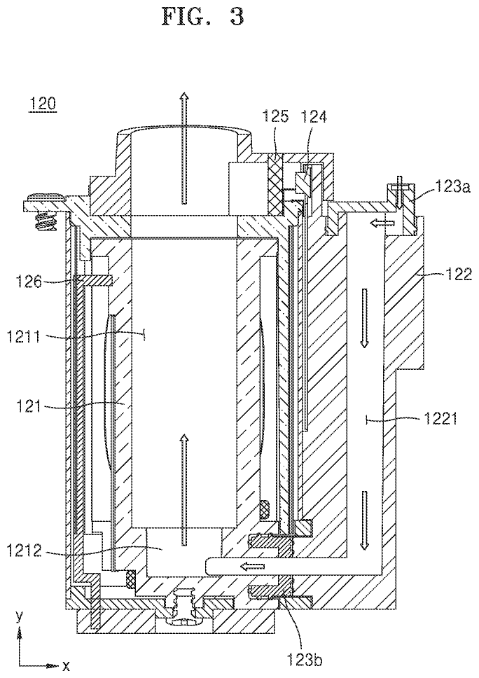

Detailed descriptions of a shape of the airflow passage 1221, a flow of external air through the airflow passage 1221, or the like are made below with reference to FIG. 3.

The aerosol generating article 200 may include an identification mark 210 at at least one region of the outer peripheral surface thereof. The identification mark 210 may surround the at least one region of the outer peripheral surface of the aerosol generating article 200.

The aerosol generating article 200 may include aerosol generating materials with different flavors depending on the type thereof. The identification mark 210 may provide different visual information depending on a type of an aerosol generating material that the aerosol generating article 200 includes. As another example, the identification mark 210 may provide different visual information depending on an amount of an aerosol generating material that the aerosol generating article 200 includes.

That is, the identification mark 210 may provide visual information to identify a type of the aerosol generating article 200. For example, the identification mark 210 may have one color. For example, the identification mark 210 may represent any one of red, green, blue, and yellow. However, a color of the identification mark 210 is not limited thereto.

As another example, the identification mark 210 may represent a QR code. As another example, the identification mark 210 may represent a barcode. However, examples in which the identification mark 210 provides visual information are not limited thereto, and the identification mark 210 may also provide visual information that may distinguish a type of the aerosol generating article 200 in a different method from the method stated above.

An article detection sensor 124 may sense visual information provided by the identification mark 210 and generate different signals according to the sensed visual information.

For example, when the identification mark 210 represents a color, the article detection sensor 124 may sense light of a color reflected by the identification mark 210 and generate a different signal according to the color of the sensed light.

As another example, when the identification mark 210 represents a QR code, the article detection sensor 124 may read information of the QR code and generate a different signal according to the information of the sensed QR code.

As another example, when the identification mark 210 represents a barcode, the article detection sensor 124 may read information of the barcode and generate a different signal according to the information of the sensed barcode.

However, examples of visual information that may be sensed by the article detection sensor 124 are not limited thereto, and the article detection sensor 124 may generate a signal by sensing visual information that may distinguish a type of the aerosol generating article 200 provided by the identification mark 210 in a method different from the method stated above.

The controller 140 may distinguish the identification mark 210 of the aerosol generating article 200 according to the signal generated by the article detection sensor 124, determine whether the aerosol generating article 200 is inserted into the receiving portion 121 and distinguish a type of an aerosol generating material that the aerosol generating article 200 includes, and control other components of the aerosol generating device 100, based on the distinguishment and determination. For example, the controller 140 may inform a type of the aerosol generating article 200 to a user according to a pre-stored algorithm depending on the type of the aerosol generating article 200. As another example, the controller 140 may select a heating method of the aerosol generating article 200 by controlling a coil according to a pre-stored algorithm depending on a type of the aerosol generating article 200.

When the aerosol generating article 200 is completely inserted into the receiving portion 121, the article detection sensor 124 may be arranged at a position corresponding to a position where the identification mark 210 is arranged.

For example, when the aerosol generating article 200 is completely inserted into the receiving portion 121, the identification mark 210 may be arranged on an upper side (+y) of the receiving portion 121, or may also be arranged on the upper side (+y) of the article detection sensor 124 and the receiving portion 121. However, positions of the identification mark 210 and/or the article detection sensor 124 are not limited thereto.

An optical window 125 is a component that is configured to protect the article detection sensor 124 and improve color sensing performance of the article detection sensor 124. The optical window 125 may include a transparent material. For example, the optical window 125 may include glass or plastic, but a material of the optical window 125 is not limited thereto.

When the aerosol generating article 200 is completely inserted into the receiving portion 121, the optical window 125 may be arranged in a space between the identification mark 210 and the article detection sensor 124.

The optical window 125 may be formed to have a curvature and may function as a lens. Accordingly, a position of a focus of light toward the article detection sensor 124 may be appropriately adjusted to improve sensing performance of visual information of the article detection sensor 124.

FIG. 3 is a cross-sectional view for explaining components arranged inside the heater module 120 of the aerosol generating device.

Hereinafter, the heater module 120 is described with reference to FIG. 3.

Some of the components of the heater module 120 may be the same or similar to the components of the heater module 120 shown in FIG. 2, and redundant descriptions are omitted below.

Referring to FIG. 3, the heater module 120 may include the receiving portion 121, the passage structure 122, a first sealing member 123a, a second sealing member 123b, the article detection sensor 124, the optical window 125, and a temperature sensor 126.

The receiving portion 121 may include a receiving space 1211 formed therein, and an aerosol generating article (not shown) may be separably coupled to the receiving space 1211. An insertion hole for inserting an aerosol generating article may be formed at an end portion of the receiving portion 121 in an upward direction (+y). The receiving portion 121 may include a cylindrical component surrounding the receiving space 1211. For example, the receiving portion 121 may include a cylindrical component with a space formed therein.

The receiving portion 121 may further include an expansion portion 1212. The expansion portion 1212 may deliver air received from the airflow passage 1221 of the passage structure 122 to the receiving space 1211. The receiving space 1211, the expansion portion 1212, and the airflow passage 1221 may be in fluid communication. The expansion portion 1212 may be arranged between the airflow passage 1221 and the receiving space 1211 and have an inner diameter greater than an inner diameter of the airflow passage 1221. In particular, the expansion portion 1212 may have an inner diameter greater than the inner diameter of the airflow passage 1221 but smaller than an inner diameter of the receiving space 1211. For example, the inner diameter of the expansion portion 1212 may be at least about 85% but not more than about 95% of the inner diameter of the receiving space 1211, and in this case, a cross-sectional area of a flow path of the expansion portion 1212 may be at least about 70% but not more than about 90% of a cross-sectional area of a flow path of the receiving space 1211.

An inner diameter of each component may be a length of an internal space in a direction perpendicular to a longitudinal direction of each component. From another perspective, an inner diameter of each component may be a length of an internal space in a direction perpendicular to a direction of aerosols flowing in the internal space of each component.

FIG. 3 illustrates that the passage structure 122 is arranged in parallel to the receiving portion 121 in a lateral direction (+x), and the expansion portion 1212 is arranged between a downstream of the airflow passage 1221 and the receiving space 1211. However, an internal structure of the heater module 120 is not limited to that shown in FIG. 3. As another example, the passage structure 122 may be arranged in series with respect to the receiving portion 121, the receiving space 1211 and the passage structure 122 may be arranged in a row in a direction (+y or −y) in which the receiving portion 121 extends, and the expansion portion 1212 may be arranged between the receiving space 1211 and the airflow passage 1221. Internal structures of the receiving portion 121 and the passage structure 122 are not limited thereto, and arrangements of components may be changed according to a design.

Air may be introduced from the outside to the inside of an aerosol generating device through the air inlet 111 (refer to FIG. 2). Air introduced into the side of the aerosol generating device may be transferred to the expansion portion 1212 by passing through the airflow passage 1221 of the passage structure 122, and may transferred to an aerosol generating article accommodated inside the receiving portion 121.

Accordingly, only one air flow may be formed, wherein the air flow is from an air inlet through which air outside the aerosol generating device is introduced to the aerosol generating article of the receiving space 1211 through the airflow passage 1221 and the expansion portion 1212. When an aerosol generating article 200 is inserted into the receiving portion 121, a user may generate the above air flow by biting and inhaling a portion of the aerosol generating article 200.

An aerosol generating device may generate aerosols by supplying electric current to a coil to heat ae aerosol generating material inside an aerosol generating article. Aerosols generated from the aerosol generating article may be transferred to the user along with flowing air introduced from the outside of the aerosol generating device.

Referring to FIG. 3, the expansion portion 1212 may be arranged between the downstream of the airflow passage 1221 and the receiving portion 121. As shown in FIG. 3, an inner diameter of the expansion portion 1212 may be formed greater than an inner diameter of the airflow passage 1221.

In an aerosol generating device including a vaporizer according to an embodiment, the expansion portion 1212 supplying air to the aerosol generating article 200 may have an inner diameter sufficiently large enough to correspond to a size of an end portion of the aerosol generating article 200. Accordingly, air may be smoothly and sufficiently supplied to an entire region of the end portion of the aerosol generating article 200.

As the inner diameter of the expansion portion 1212 is formed larger than the inner diameter of the airflow passage 1221, the pressure and flow rate of air when passing through the expansion portion 1212 may be reduced compared to the pressure and flow rate of air when passing through the airflow passage 1221. The expansion portion 1212 may prevent excessive flow of air from occurring at an upstream of the receiving portion 121 by reducing the pressure and flow rate of air received from the airflow passage 1221.

Also, the expansion portion 1212 is a component that directly transfers air to the aerosol generating article 200 inside the receiving portion 121, and an amount of air transferred to the aerosol generating article 200 is proportional to an amount of aerosols generated, and thus an amount of aerosols supplied per unit of time to the user may be increased by enlarging the inner diameter of the expansion portion 1212. As the inner diameter of the expansion portion 1212 is closer to the inner diameter of the receiving portion 121, a greater amount of air may be transferred to the aerosol generating article 200, and more aerosols may be generated.

The expansion portion 1212 may adjust pressure of air flowing from the airflow passage 1221 to the receiving space 1211 to supply the air to the aerosol generating article 200.

Air that has reached the expansion portion 1212 may enter the receiving space 1211 as the pressure thereof is reduced in the expansion portion 1212. Air that has reached the expansion portion 1212 may be expanded inside the expansion portion 1212 as the pressure thereof is reduced in the expansion portion 1212 having a greater inner diameter than that of the airflow passage 1221. The expanded air may spread throughout an entire area of the inside of the expansion portion 1212 to form a constant pressure over an entire area of end portions of the aerosol generating article 200 in a downward direction (−y direction), and accordingly, air may be supplied more evenly to the entire area of the end portions of the aerosol generating article 200.

The passage structure 122 may include the airflow passage 1221 receiving external air from the air inlet 111 and a pressure sensor that generates signals regarding a pressure inside the airflow passage 1221. A detailed description of a pressure sensor is made below with reference to FIG. 4.

Only one airflow passage 1221 may be formed in the passage structure 122. Also, a pressure sensor (not shown) may be in communication with a portion of the airflow passage 1221 to measure a pressure inside the airflow passage 1221.

The first sealing member 123a may be arranged between the air inlet 111 (refer to FIG. 2) and the passage structure 122. The first sealing member 123a is a component that is configured to prevent air introduced through the air inlet 111 from leaking into structures or spaces other than the airflow passage 1221 inside the passage structure 122.

For example, the first sealing member 123a may be arranged to surround and be in close contact with the air inlet 111 and/or at least a portion of the passage structure 122. Air introduced through the air inlet 111 is prevented from leaking into structures or spaces other than the airflow passage 1221 inside the passage structure 122 through the first sealing member 123a.

The first sealing member 123a may include silicon, rubber, and/or plastic, or the like, bit a material of the first sealing member 123a is not limited thereto.

The second sealing member 123b may be arranged between the passage structure 122 and the receiving portion 121. The second sealing member 123b is a component that is configured to prevent air received through the airflow passage 1221 of the passage structure 122 from leaking into structures or spaces other than the receiving portion 121.

For example, the second sealing member 123b may be arranged to surround and be in close contact with at least a portion of the receiving portion 121. Air introduced through the airflow passage 1221 may be prevented from leaking into structures or spaces other than the receiving space 1211 or the expansion portion 1212 inside the receiving portion 121 through the second sealing member 123b.

The second sealing member 123b may include silicon, rubber, plastic, or the like, and a material of the second sealing member 123b is not limited thereto.

The temperature sensor 126 is a component that generates a signal about temperature. For example, the temperature sensor 126 may sense a temperature at which the aerosol generating article 200 is heated and generate a signal about the temperature. The temperature sensor 126 may include a thermocouple, but is not limited thereto. A particular arrangement of the temperature sensor 126 is described below.

A controller (refer to FIG. 2) may sense a temperature of an aerosol generating article according to a signal generated by the temperature sensor 126 and control other components of the aerosol generating device, based on the sensed temperature. For example, the controller may control a heating temperature of an aerosol generating article by controlling a coil according to a pre-stored algorithm depending on a temperature of the aerosol generating article.

FIG. 4 is a front view for explaining components arranged outside a heater module of an aerosol generating device. Some of the components of the heater module 120 may be the same or similar to the components of the heater module 120 shown in FIG. 3, and thus redundant descriptions are omitted below.

The pressure sensor 1222 may be arranged on one surface of the passage structure 122. The passage structure 122 may include a passage (not shown) for connecting the pressure sensor 1222 to the airflow passage 1221 (refer to FIG. 3), and may further include a component such as a groove or the like in which the pressure sensor 1222 is arranged.

The pressure sensor 1222 may generate a signal about a pressure inside the airflow passage 1221 (refer to FIG. 3), based on various physical changes inside the airflow passage 1221. For example, the pressure sensor 1222 may generate a signal about a pressure inside the airflow passage, based on any one of a temperature change, a flow change, a voltage change, and a pressure change.

When there are a plurality airflows of air introduced from the outside, a pressure of any one of the airflows is measured, and thus the accuracy and sensitivity of pressure measurement may be decreased.

According to an embodiment, the passage structure 122 may include one airflow passage, and only one airflow of air introduced from the outside may occur, and thus the accuracy and sensitivity of pressure measurement inside the airflow passage may be improved.

A controller (refer to FIG. 2) may sense a user's puff according to a signal generated by the pressure sensor 1222 and control other components of the aerosol generating device, based on the sensed user's puff.

Air introduced through the air inlet 111 may be prevented from leaking into structures or spaces other than the airflow passage inside the passage structure 122 through the first sealing member 123a, and as the passage structure 122 includes only one airflow, the accuracy and sensitivity of pressure measurement inside the airflow passage of the pressure sensor 1222 may be improved.

As described above, the heater module 120 may further include a second sealing member (refer to FIG. 3) arranged between the passage structure 122 and the receiving portion 121, and air introduced through the airflow passage may be prevented from leaking into structures or spaces other than a receiving space or an expansion portion inside the receiving portion 121. With this structure, only one airflow passing through an airflow passage an airflow passage, an expansion portion, and a receiving space may be generated, and thus the accuracy and sensitivity of pressure measurement with respect to an airflow of the pressure sensor 1222 may be further improved.

A coil 127 is a component that generates a magnetic field. The coil 127 may be arranged along the outer peripheral surface of the receiving portion 121. The coil 127 may generate a magnetic field in a direction crossing a direction (+y or −y) in which the receiving portion 121 extends. For example, the coil 127 may generate a magnetic field in a direction perpendicular to the direction in which the receiving portion 121 extends. A description about a direction of a magnetic field generated by the coil 127 and the receiving portion 121 is made in detail below with reference to FIG. 5.

One or more coils 127 may be arranged. For example, three coils 127 may be arranged to surround the receiving portion 121, but the disclosure is not limited thereto.

Referring to FIG. 4, the coil 127 may be formed in a shape in which a conductive wire through which current may flow is wound several times. Unlike a solenoid-shaped coil that is wound around a virtual cylinder multiple times with the same diameter, the coil 127 according to an embodiment may be formed in a shape in which a diameter thereof gradually increases as being wound around a virtual central axis multiple times. The coil 127 may form a curved surface. The coil 127 may be arranged to surround at least a portion of an outer peripheral surface of the receiving portion 121.

The coil 127 may be curvedly formed in a shape corresponding to the outer peripheral surface of the receiving portion 121 to surround a portion of the outer peripheral surface of the receiving portion 121, and may be arranged to maintain a certain distance from the outer peripheral surface of the receiving portion 121 at any point of the coil 127. A center point around which the coil 127 is would may be arranged at one point on the outer peripheral surface of the receiving portion 121.

The heater module 120 may include a plurality of coils 127, and the plurality of coils 127 may be electrically connected to each other. The coil 127 may be electrically connected to a battery to receive current from the battery. An alternating current may be applied to the coil 127 so that the coil 127 generates a magnetic field. A resonance frequency caused by the alternating current applied to the oil 127c may be at least about 1 MHz but not more than about 10 MHz.

FIG. 5 is a cross-sectional view for explaining arrangements of a receiving portion and a coil of a heater module of an aerosol generating device, and a direction of a magnetic field.

Components such as the receiving portion 121 and the coil 127 may be the same or similar to some of components shown in FIG. 4, and redundant descriptions are omitted below.

The coil 127 may be arranged along the outer peripheral surface of the receiving portion 121. The coil 127 may include a first coil 1271 and a second coil 1272. The first coil 1271 and the second coil 1272 may be arranged along the outer peripheral surface of the receiving portion 121 to be spaced apart from each other at a certain interval. The coil 127 may be arranged so that a virtual central axis around which the coil 127 is wound crosses a direction (+y or −y) in which the receiving portion 121 extends. For example, the coil 127 may be arranged so that the virtual central axis around which the coil 127 is wound faces toward a direction (a +z or −z direction) perpendicular to the direction (+y or −y) in which the receiving portion 121 extends, but an arrangement of the coil 127 is not limited thereto.

In this arrangement, according to Ampere's Law, a magnetic field M by the coil 127 may pass through the receiving portion 121 across the direction in which the receiving portion 121 extends. According to Ampere's Law, a direction of the magnetic field M formed by the coil 127 is identical to a direction of the virtual central axis around which the coil 127 is wound. An angle formed by a direction in which the magnetic field M passes through the inside of the receiving portion 121 and a direction in which the receiving portion 121 extends may form approximately a right angle.

An alternating current may be applied to the coil 127 so that the coil 127 generates the magnetic field M. A resonance frequency caused by the alternating current applied to the oil 127c may be at least about 1 MHz but not more than about 10 MHz.

‘X’ indicated on a cross section of a conductive wire forming the coil 127 of FIG. 5 means a state in which current is entered when viewing a cross-sectional view, and ‘.’ indicated on the cross section of the conductive wire means a state in which current comes out when viewing the cross-sectional view. When an alternating current is applied to the coil 127, a direction of current flowing in the coil 127 continues to change according to a cycle of the alternating current, and a direction of current shown in FIG. 5 may be seen as a temporary state at a particular point in time.

The magnetic field M formed by the coil 127 may pass through a space inside the receiving portion 121 in a direction crossing the direction in which the receiving portion 121 extends. The magnetic field M may pass through a thin film included in an aerosol generating article (not shown) accommodated in the receiving space 1211 inside the receiving portion 121 and heat the thin film. At least a portion of the magnetic field M generated by the coil 127 may be applied in a direction perpendicular to at least one surface of the thin film.

When a thin film is used as a susceptor by the magnetic field M of the coil 127, a heating surface relative to a mass may be expanded, and a heating efficiency may be increased, and thus power efficiency may be improved. Also, because a separate susceptor configuration may be included in an aerosol generating article instead of being included in an aerosol generating device, a space inside the aerosol generating device may be secured, and an internal space of the aerosol generating device may be used more efficiently.

An aerosol generating article may be arranged in the receiving space 1211 so that a direction in which a thin film extends is the same as the direction in which the receiving portion 121 extends. In this arrangement, because a direction of the magnetic field M generated by the coil 127 crosses the direction in which the thin film extends, a density of the magnetic field M passing through the thin film may be increased compared to a case in which a solenoid-shaped coil is applied, and a heating efficiency of the thin film may be improved.

At least a portion of the thin film may be arranged at a position corresponding to a position of the coil 127 based on when the aerosol generating article is completely accommodated in the receiving portion 121.

According to an embodiment, even when the thin film is thinly spread in a longitudinal direction of the receiving portion 121, the magnetic field M generated by the coil 127 may pass through an entire large area of the thin film, and thus the magnetic field M with a sufficient density may be applied to the thin film, the thin film may heat the aerosol generating article 200 to a sufficient temperature.

The plurality of coils 127 may have the same size and shape, and at least some of the coils 127 may be arranged symmetrically with respect to the receiving portion 121.

Also, at least some of the coils 127 may be arranged to face each other with the receiving portion 121 therebetween. At least some of the coils 127 may be arranged to be spaced apart from each other at regular intervals.

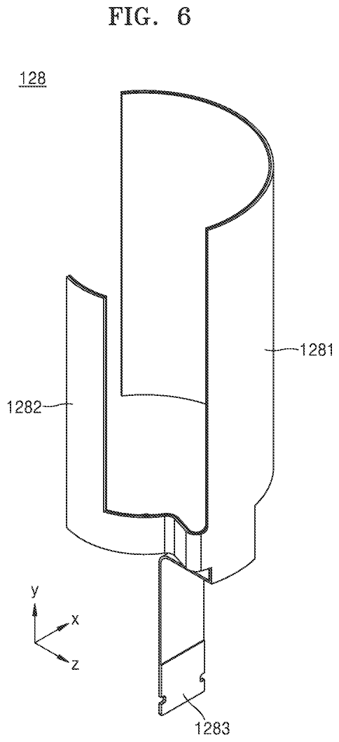

FIG. 6 is a perspective view for explaining a circuit board formed integrally with sensors.

The aerosol generating device 100 described with reference to FIGS. 1 to 3 may include a circuit board 128. The circuit board 128 may be formed in a structure in which a conductor and an insulator are stacked in a form of a board. A plurality of components may be electrically connected to the circuit board 128. The circuit board 128 may be a flexible printed circuit board (FPCB).

The circuit board 128 may include an inductance sensor 1281 that generates a signal about a change in inductance, a capacitance sensor 1282 that generates a signal about a change in capacitance, and a circuit connection portion 1283.

The circuit board 128 may be integrally formed by including the inductance sensor 1281 and the capacitance sensor 1282. The inductance sensor 1281 and/or the capacitance sensor 1282 may be electrically connected to other components of the aerosol generating device through the circuit connection portion 1283. For example, the inductance sensor 1281 and/or the capacitance sensor 1282 may receive power from a battery (not shown) through the circuit connection portion 1283.

The inductance sensor 1281 may include a curved shape. The inductance sensor 1281 may generate a signal about a change in inductance inside the curved surface. When a particular object approaches or moves away from the inductance sensor 1281, a change in inductance may occur, and the approaching or moving away of the object may be sensed through the change in inductance.

The capacitance sensor 1282 may include two plates. The two plates are conductive materials, and may each include a thin film material such as a polymer that acts as a dielectric body. A capacitance between the two plates changes according to a change in relative humidity of air surrounding the capacitance sensor 1282.

The relative humidity of air surrounding the capacitance sensor 1282 may be determined by measuring the capacitance between the two plates of the capacitance sensor 1282.

The accuracy and reliability of humidity measurement of the capacitance sensor 1282 may be further improved by using with other techniques, such as inductance measurement of the inductance sensor 1281 or RC(Resistor-Capacitor) vibration.

The two plates of the capacitance sensor 1282 may be referred to as one channel. For example, the capacitance sensor 1282 may simultaneously measure the capacitance of a plurality of portions by including a plurality of channels. The resolution or accuracy of capacitance sensing may be improved through the plurality of channels. For example, the capacitance sensor 1282 may sense the relative humidity of two regions by including two channels.

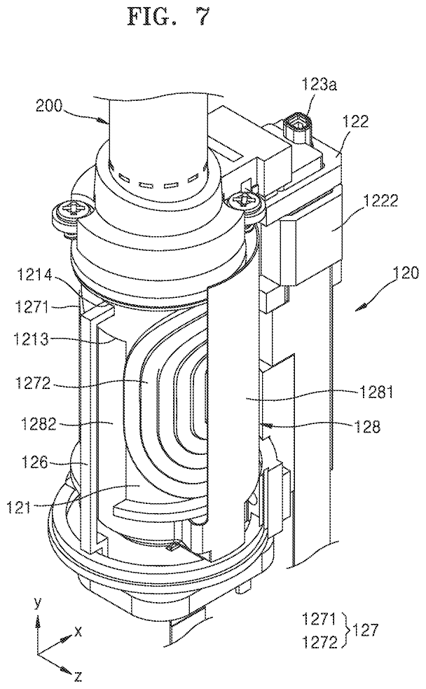

FIG. 7 is a perspective view for explaining components arranged outside a heater module of an aerosol generating device from another angle.

The heater module 120 may include a configuration that is same as or similar to the circuit board 128 described above with reference to FIG. 6.

The inductance sensor 1281 of the circuit board 128 may have a curved surface, and the receiving portion 121 may be arranged inside the curved surface.

The inductance sensor 1281 may generate a signal about a change in inductance inside the receiving portion 121, and a controller may sense the signal about the change in inductance inside the receiving portion 121 to determine an insertion or removal of the aerosol generating article 200 with respect to the receiving space 1211.

The controller may control other components of the aerosol generating device 100 according to the signal generated by the inductance sensor 1281. For example, when the controller determines that the aerosol generating article 200 has been removed from the receiving space 1211 according to the signal generated by the inductance sensor 1281, the controller may stop an operation of the aerosol generating device 100, and when the controller determines that the aerosol generating article 200 has been inserted into the receiving space 1211, the controller may start the operation of the aerosol generating device 100.

The capacitance sensor 1282 may generate a signal about a change in capacitance inside the receiving portion 121, and the controller may sense a humidity inside the receiving space 1211 by sensing the signal about the change in capacitance inside the receiving portion 121. The capacitance sensor 1282 may generate a signal, based on an amount of change in humidity inside the receiving space 1211 by measuring a change in capacitance and/or a change in dielectric constant between two plates thereof.

At least a portion of aerosols generated in the receiving space 1211 may be liquefied, and the liquefied aerosol may include some moisture. In an embodiment, the capacitance sensor 1282 may generate a signal, based on an amount of aerosol (or moisture) which is wet or on the aerosol generating article 200. As a signal about moisture sensed by the capacitance sensor 1282 is provided to the controller, the controller may sense information about moisture and/or humidity inside the receiving space 1211.

In addition to the capacitance sensor 1282, the heater module 120 may include a humidity sensor that measures humidity of the receiving space 1211 and/or the aerosol generating article 200 according to another principle.

A use life span of the aerosol generating article 200 may be set in advance. Whether the use life span of the aerosol generating article 200 has been exceeded may be determined by measuring humidity (or moisture) of the aerosol generating article 200. For example, the capacitance sensor 1282 may sense an amount of humidity (or moisture) of the aerosol generating article 200, and when a value sensed by the capacitance sensor 1282 exceeds a preset value, it may be seen that the use life span of the aerosol generating article 200 has been exceeded.

The heater module 120 may include two or more coils 127. For example, the coil 127 may include the first coil 1271 and the second coil 1272. The first coil 1271 and the second coil 1272 may be arranged along the outer peripheral surface of the receiving portion 121 to be spaced apart from each other at a certain interval.

A first groove 1213 may be recessed in the outer peripheral surface of the receiving portion 121. In particular, the first groove 1213 may be formed between the first coil 1271 and the second coil 1272 in the outer peripheral surface of the receiving portion 121. The inductance sensor 1281 or the capacitance sensor 1282 may be arranged in the first groove 1213.

For example, the capacitance sensor 1282 may be coupled to the first groove 1213 formed between the first coil 1271 and the second coil 1272 to be in contact with the outer peripheral surface of the receiving portion 121.

As another example, the inductance sensor 1281 may also be coupled to the first groove 1213 formed between the first coil 1271 and the second coil 1272 to be in contact with the outer peripheral surface of the receiving portion 121.

A second groove 1214 may be recessed in the outer peripheral surface of the receiving portion 121. Like the first groove 1213, the second groove 1214 may also be formed between the first coil 1271 and the second coil 1272 in the outer peripheral surface of the receiving portion 121.

For example, the temperature sensor 126 described above may be arranged in the second groove 1214. However, the disclosure is not limited thereto, and the inductance sensor 1281 or the capacitance sensor 1282 may also be arranged in the second groove 1214.

In summary, the coil 127 may include the first coil 1271 and the second coil 1272, and the first coil 1271 and the second coil 1272 may be arranged along the outer peripheral surface of the receiving portion 121 to be spaced apart from each other at a certain interval. Also, the temperature sensor 126, the inductance sensor 1281, and/or the capacitance sensor 1282 may be arranged between the first coil 1271 and the second coil 1272, and the above sensors may be arranged in the first groove 1213 and/or the second groove 1214 recessed in the receiving portion 121. According to this structure, because the sensors are arranged closer to the receiving space 1211, various physical quantities such as humidity, temperature, capacitance, inductance, or the like inside the receiving space 1211 may be measured more sensitively and accurately.

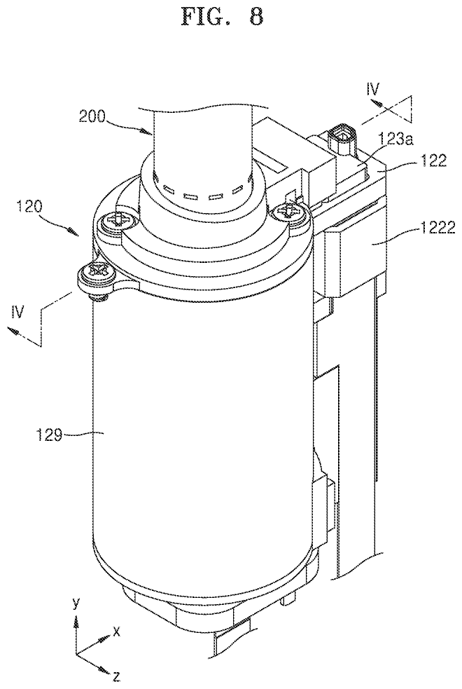

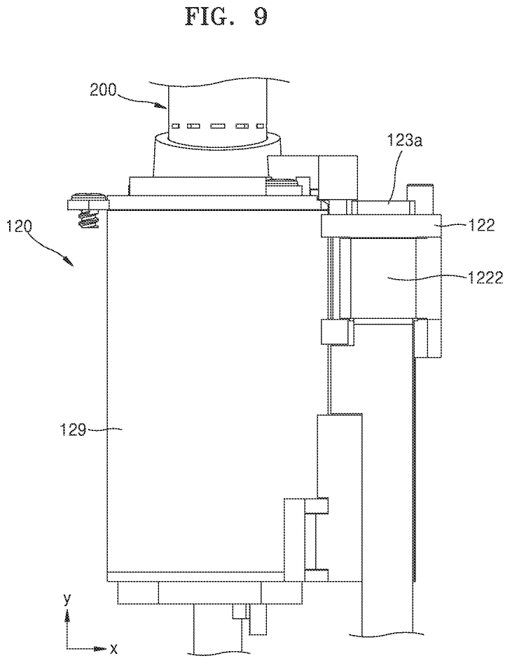

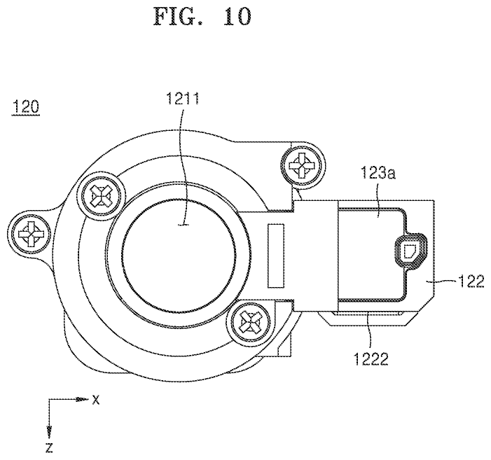

FIG. 8 is a perspective view for explaining an insulation pipe 129 surrounding a receiving portion of the heater module 120. FIG. 9 is a front view for explaining the insulation pipe 129 surrounding the receiving portion of the heater module 120 from another angle. FIG. 10 is a top view for explaining the insulation pipe 129 surrounding the receiving portion of the heater module 120 from another angle. Hereinafter, the insulation pipe 129 is described in detail with reference to FIGS. 8 to 10.

According to an embodiment, the heater module 120 may include the insulation pipe 129. The insulation pipe 129 is a component that is configured to reduce an amount of heat inside the receiving space 1211 transferred to a housing or the like of the aerosol generating device. The insulation pipe 129 may include a material such as a vacuum tube, metal, or the like. For example, the insulation pipe 129 may include a metal material such as aluminum, stainless steel or the like. The insulation pipe 129 may protect the user from risks such as burns that may occur when the user holds the aerosol generating device.

A shape of the insulation pipe 129 may be formed to correspond to a shape of an exterior of the receiving portion 121. For example, the insulation pipe 129 may be formed similar to a hollow cylinder, or may be formed in a shape of a rectangular parallelepiped, but the shape of the insulation pipe 129 is not limited thereto.

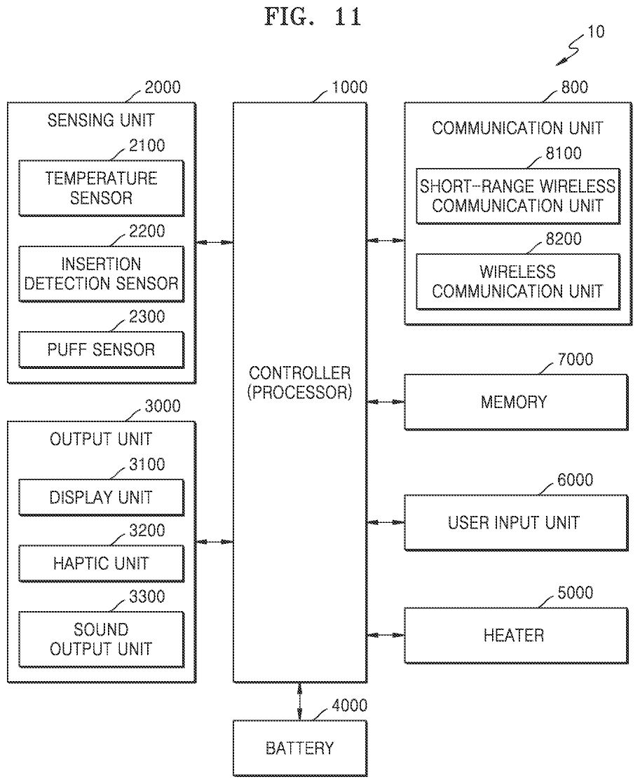

FIG. 11 is a block diagram of an aerosol generating device according to another embodiment.

An aerosol generating device 10 may include a controller 1000, a sensing unit 2000, an output unit 3000, a battery 4000, a heater 5000, a user input unit 6000, a memory 7000, and a communication unit 8000. However, the internal structure of the aerosol generating device 10 is not limited to those illustrated in FIG. 11. That is, according to the design of the aerosol generating device 10, it will be understood by one of ordinary skill in the art that some of the components shown in FIG. 11 may be omitted or new components may be added.

The sensing unit 2000 may sense a state of the aerosol generating device 10 and a state around the aerosol generating device 10, and transmit sensed information to the controller 1000. Based on the sensed information, the controller 1000 may control the aerosol generating device 10 to perform various functions, such as controlling an operation of the heater 5000, limiting smoking, determining whether an aerosol generating article (e.g., a cigarette, a cartridge, or the like) is inserted, displaying a notification, or the like.

The sensing unit 2000 may include at least one of a temperature sensor 2100, an insertion detection sensor 2200, and a puff sensor 2300, but is not limited thereto.

The temperature sensor 2100 may sense a temperature at which the heater 5000 (or an aerosol generating material) is heated. The aerosol generating device 10 may include a separate temperature sensor for sensing the temperature of the heater 5000, or the heater 5000 may serve as a temperature sensor. Alternatively, the temperature sensor 2100 may also be arranged around the battery 4000 to monitor the temperature of the battery 4000.

The insertion detection sensor 2200 may sense insertion and/or removal of an aerosol generating article. For example, the insertion detection sensor 2200 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 2300 may sense a user's puff on the basis of various physical changes in an airflow passage or an airflow channel. For example, the puff sensor 2300 may sense a user's puff on the basis of any one of a temperature change, a flow change, a voltage change, and a pressure change.

The sensing unit 2000 may further include, in addition to the temperature sensor 2100, the insertion detection sensor 2200, and the puff sensor 2300 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 3000 may output information on a state of the aerosol generating device 10 and provide the information to a user. The output unit 3000 may include at least one of a display unit 3100, a haptic unit 3200, and a sound output unit 3300, but is not limited thereto. When the display unit 3100 and a touch pad form a layered structure to form a touch screen, the display unit 3100 may also be used as an input device in addition to an output device.

The display unit 3100 may visually provide information about the aerosol generating device 10 to the user. For example, information about the aerosol generating device 10 may mean various pieces of information, such as a charging/discharging state of the battery 4000 of the aerosol generating device 10, a preheating state of the heater 5000, an insertion/removal state of an aerosol generating article, or a state in which the use of the aerosol generating device 10 is restricted (e.g., sensing of an abnormal object), or the like, and the display unit 3100 may output the information to the outside. The display unit 3100 may be, for example, a liquid crystal display panel (LCD), an organic light-emitting diode (OLED) display panel, or the like. In addition, the display unit 3100 may be in the form of a light-emitting diode (LED) light-emitting device.

The haptic unit 3200 may tactilely provide information about the aerosol generating device 10 to the user by converting an electrical signal into a mechanical stimulus or an electrical stimulus. For example, the haptic unit 3200 may include a motor, a piezoelectric element, or an electrical stimulation device.

The sound output unit 3300 may audibly provide information about the aerosol generating device 10 to the user. For example, the sound output unit 3300 may convert an electrical signal into a sound signal and output the same to the outside.

The battery 4000 may supply power used to operate the aerosol generating device 10. The battery 4000 may supply power such that the heater 5000 may be heated. In addition, the battery 4000 may supply power required for operations of other components (e.g., the sensing unit 2000, the output unit 3000, the user input unit 6000, the memory 7000, and the communication unit 8000) in the aerosol generating device 10. The battery 4000 may be a rechargeable battery or a disposable battery. For example, the battery 4000 may be a lithium polymer (LiPoly) battery, but is not limited thereto.

The heater 5000 may receive power from the battery 4000 to heat an aerosol generating material. Although not illustrated in FIG. 11, the aerosol generating device 10 may further include a power conversion circuit (e.g., a direct current (DC)/DC converter) that converts power of the battery 4000 and supplies the same to the heater 5000. In addition, when the aerosol generating device 10 generates aerosols in an induction heating method, the aerosol generating device 10 may further include a DC/alternating current (AC) converter that converts DC power of the battery 4000 into AC power.

The controller 1000, the sensing unit 2000, the output unit 3000, the user input unit 6000, the memory 7000, and the communication unit 8000 may each receive power from the battery 4000 to perform a function. Although not illustrated in FIG. 11, the aerosol generating device 10 may further include a power conversion circuit that converts power of the battery 4000 to supply the power to respective components, for example, a low dropout (LDO) circuit, or a voltage regulator circuit.

In an embodiment, the heater 5000 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 5000 may be implemented by a metal wire, a metal plate on which an electrically conductive track is arranged, or a ceramic susceptor, but is not limited thereto.

In another embodiment, the heater 5000 may be a heater of an induction heating type. For example, the heater 5000 may include a susceptor that heats an aerosol generating material by generating heat through a magnetic field applied by a coil.

The user input unit 6000 may receive information input from the user or may output information to the user. For example, the user input unit 6000 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 11, the aerosol generating device 10 may further include a connection interface, such as a universal serial bus (USB) interface, and may be connected to other external devices through the connection interface, such as the USB interface, to transmit and receive information, or to charge the battery 4000.

The memory 7000 is a hardware component that stores various types of data processed in the aerosol generating device 10, and may store data processed and data to be processed by the controller 1000. The memory 7000 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 7000 may store an operation time of the aerosol generating device 10, the maximum number of puffs, the current number of puffs, at least one temperature profile, data on a user's smoking pattern, etc.

The communication unit 8000 may include at least one component for communication with another electronic device. For example, the communication unit 8000 may include a short-range wireless communication unit 8100 and a wireless communication unit 8200.

The short-range wireless communication unit 8100 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra wideband (UWB) communication unit, an Ant+ communication unit, or the like, but is not limited thereto.

The wireless communication unit 8200 may include a cellular network communication unit, an Internet communication unit, a computer network (e.g., local area network (LAN) or wide area network (WAN)) communication unit, or the like, but is not limited thereto. The wireless communication unit 8200 may also identify and authenticate the aerosol generating device 10 within a communication network by using subscriber information (e.g., International Mobile Subscriber Identifier (IMSI)).

The controller 1000 may control the overall operation of the aerosol generating device 10. In an embodiment, the controller 1000 may include at least one processor. The processor may be implemented as an array of a plurality of logic gates, or may be implemented as a combination of a general-purpose microprocessor and a memory in which a program executable by the microprocessor is stored. It will be understood by one of ordinary skill in the art that the processor may be implemented in other forms of hardware.

The controller 1000 may control the temperature of the heater 5000 by controlling supply of power of the battery 4000 to the heater 5000. For example, the controller 1000 may control power supply by controlling switching of a switching element between the battery 4000 and the heater 5000. In another embodiment, a direct heating circuit may also control power supply to the heater 5000 according to a control command of the controller 1000.

The controller 1000 may analyze a result sensed by the sensing unit 2000 and control subsequent processes to be performed. For example, the controller 1000 may control power supplied to the heater 5000 to start or end an operation of the heater 5000 on the basis of a result sensed by the sensing unit 2000. In another embodiment, the controller 1000 may control, based on a result sensed by the sensing unit 2000, an amount of power supplied to the heater 5000 and the time the power is supplied, such that the heater 5000 may be heated to a certain temperature or maintained at an appropriate temperature.

The controller 1000 may control the output unit 3000 on the basis of a result sensed by the sensing unit 2000. For example, when the number of puffs counted through the puff sensor 2300 reaches a preset number, the controller 1000 may notify the user that the aerosol generating device 10 will soon be terminated through at least one of the display unit 3100, the haptic unit 3200, and the sound output unit 3300.

One embodiment may also be implemented in the form of a computer-readable recording medium including instructions executable by a computer, such as a program module executable by the computer. The computer-readable recording medium may be any available medium that may be accessed by a computer, and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

An aerosol generating device and an aerosol generating system including the aerosol generating device according to various embodiments may improve space efficiency and miniaturize the size of the aerosol generating device by including a susceptor in an aerosol generating article.

The aerosol generating device and the aerosol generating system including the aerosol generating device according to various embodiments may include a susceptor in a thin-film shape to increase a heating area of the susceptor and improve a heating efficiency.

The aerosol generating device and the aerosol generating system including the aerosol generating device according to various embodiments may include one airflow passage and improve positions of sensors sensing physical quantities such as air pressure, temperature, humidity, or the like to improve sensing performance of the physical quantities.

Technical problems to be solved by the embodiments are not limited to the above-described problems, and problems that are not mentioned will be clearly understood by those of ordinary skill in the art from the disclosure and the accompanying drawings.

1. An aerosol generating device comprising:
a housing comprising an air inlet through which air is introduced; and
a heater module arranged inside the housing and configured to heat an aerosol generating article,
wherein the heater module comprises: a receiving portion having a receiving space for accommodating the aerosol generating article;
one or more coils configured to generate a magnetic field;
a passage structure arranged on one side of the receiving portion and comprising one airflow passage configured to receive external air through the air inlet and transfer the received external air to the receiving portion; and
a pressure sensor configured to generate a signal about a pressure inside the airflow passage.

2. The aerosol generating device of claim 1, wherein the one or more coils are arranged along an outer peripheral surface of the receiving portion and configured to generate a magnetic field in a direction crossing a direction in which the receiving portion extends.

3. The aerosol generating device of claim 1, wherein the heater module further comprises a first sealing member arranged between the air inlet and the passage structure and configured to prevent air received through the air inlet from leaking into spaces other than an inside of the airflow passage.

4. The aerosol generating device of claim 1, wherein the heater module further comprises a second member arranged between the passage structure and the receiving portion and configured to prevent air moved through the airflow passage from leaking into spaces other than an inside of the receiving portion.

5. The aerosol generating device of claim 1, wherein the receiving portion comprises an expansion portion arranged between the airflow passage and the receiving space, having an inner diameter greater than an inner diameter of the airflow passage but smaller than an inner diameter of the receiving space, and configured to transfer air transferred from the airflow passage to the receiving space.

6. The aerosol generating device of claim 1, wherein the heater module further comprises an insulation pipe surround the receiving portion and comprising a metal material.

7. The aerosol generating device of claim 1, wherein the heater module further comprises a circuit board,
wherein the circuit board comprises: an inductance sensor configured to generate a signal about an amount of change in inductance inside the receiving portion; and
a capacitance sensor configured to generate a signal about an amount of change in capacitance inside the receiving portion.

8. The aerosol generating device of claim 7, wherein a first groove is in at least a region of an outer peripheral surface of the receiving portion, and
the capacitance sensor is coupled to the first groove and in contact with the receiving portion.

9. The aerosol generating device of claim 8, wherein the one or more coils comprise a first coil and a second coil, which are arranged along the outer peripheral surface of the receiving portion, and
the first groove is between the first coil and the second coil.

10. The aerosol generating device of claim 1, wherein a second groove is recessed in at least a region of an outer peripheral surface of the receiving portion, and
the heater module further comprises a temperature sensor coupled to the second groove of the receiving portion, in contact with the receiving portion, and generating a signal about a temperature of aerosol generating article.

11. An aerosol generating system comprising:
the aerosol generating device of claim 1; and
an aerosol generating article comprising one or more thin films that generate heat by a magnetic field,
wherein the one or more coils apply a magnetic field to the one or more thin films of the aerosol generating article accommodated in the receiving portion.

12. The aerosol generating system of claim 11, wherein at least some of the one or more thin films are arranged at positions corresponding to positions of the one or more coils.

13. The aerosol generating system of claim 11, wherein at least a portion of the magnetic field generated by the one or more coils is applied in a direction crossing a direction in which one surface of the one or more thin films extends.

14. The aerosol generating system of claim 11, wherein the aerosol generating article comprises an identification mark arranged on at least one region of an outer peripheral surface of the aerosol generating article and configured to provide visual information, and
the heater module further comprises an article detection sensor configured to sense the visual information provided by the identification mark and generate a signal according to the sensed visual information.

15. The aerosol generating system of claim 14, wherein the heater module further comprises an optical window arranged in a space between the aerosol generating article and the article detection sensor.
